(19) United States
(12) Patent Application Publication
(10) Pub. No.: US 2014/0031960 A1
(43) Pub. Date: Jan. 30, 2014

(54) SYSTEM AND METHOD FOR PRESENTING ADVERTISEMENTS IN ASSOCIATION WITH MEDIA STREAMS

(71) Applicant: Michael Hill, Santa Barbara, CA (US)

(72) Inventor: Michael Hill, Santa Barbara, CA (US)

(73) Assignee: RADIOLOYALTY, INC., Santa Barbara, CA (US)

(21) Appl. No.: 13/559,503

(22) Filed: Jul. 26, 2012

(51) Int. Cl. G06F 3/16

(52) U.S. Cl. CPC G06F 3/165
USPC 700/94

(57) ABSTRACT

A system and related method are provided for presenting advertisements in association with a media stream in a network environment, without interrupting the media stream. The advertisements are provided in a real-time and targeted manner to maximize advertisement revenue. The advertisements replace advertisements otherwise provided within the media stream.

### FIELD OF THE INVENTION

The present invention relates generally to providing advertisements within a media player and, more particularly, to a system and method for presenting advertisements in association with media streams.

### BACKGROUND OF THE INVENTION

Streaming media provides a wide range of media content that appeals to many users. For example, Internet radio includes various genres of music and talk radio, including international broadcasts that are not available in local radio broadcasts and can only be accessed through Internet radio. With the increase of Internet access and wireless devices, Internet radio has been gaining popularity.

Streaming typically involves continually transmitting digital packets of media content to a client device as it plays back the broadcast virtually in real time. The data transmitted in the stream typically include metadata. Metadata typically provides information related to the media stream. For example, an Internet radio station can use metadata to display information about the audio content that is being played, such as the title and artist of the content, the duration of the content, the album corresponding to the content, and the album image of the content. Other features include information about upcoming content on the current radio station, the bitrate, and format of the content, and the ability to view the content playing on other stations. By providing a more informative and user-friendly listening experience, listeners are increasingly favoring Internet radio over traditional radio.

Internet radio also provides advertisers with many advantages over traditional radio. Improvements in connection quality and speed allow the simultaneous streaming of images, video, and other multimedia content along with the radio broadcast. Website links to corresponding advertisements can be provided to allow greater interactivity with the user.

Like traditional radio, Internet radio advertisements are sold in time-based slots at varied intervals during the radio broadcast. Once sold, the advertisement is inserted or embedded in the stream before delivery. Generally, once the advertisement is inserted into the stream, it cannot be changed or altered without the errors and cost of constant reprogramming. Thus, it is impractical for radio broadcasters to alter advertisements for a last minute optimization of the stream, based on current listener demographics.

Moreover, since radio stations make most of their revenue through advertisements, it is desirable for broadcasters to sell time slots to the highest bidder. Since advertisements have to be inserted or embedded in advance, broadcasters are restricted from selling time slots for a period of time before the stream is delivered. Demographic information is highly relevant to advertisers. Thus, the ability to target ads to a particular listener demographic can have strong impact on the ad rates. However, current approaches require broadcasters to sell advertisement at rates that account for the broad demographic characterization of the listenership rather than more targeted advertisements.

In view of the foregoing, it should therefore be appreciated that there remains a need for a system and method of replacing advertisements to optimize revenue while minimizing costs and errors of last minute reprogramming.

### SUMMARY OF THE INVENTION

Briefly, and in general terms, the invention provides a computerized system and method for presenting advertisements in association with a media stream in a network environment. The advertisements are provided in a real-time and targeted manner to maximize advertisement revenue.

More specifically, by example and not limitation, the system and method can further provide that a client device that, while playing a media stream received, can monitor the media stream for indicators of advertisement segments. The client device can further receive replacement advertisements, and play the replacement advertisement sequenced by a trigger point such that the replacement advertisement is initiated to play unmuted while the audio-stream component of the media stream is played muted, without need of user action.

In a detailed aspect of an exemplary embodiment, the indicator can include timing information of the duration of the scheduled advertisement segment. The indicator can be a key-value pair provided in metadata of the media stream, in which the value indicates the duration of the advertisement segment. The key component of the key-value pair can be used by the system to elect a particular subset of ad buckets.

In another detailed aspect of an exemplary embodiment, the client device can identify a trigger point indicating the transition from a content segment to an advertisement segment of the media stream, so that is can properly sequence playing of the replacement ad, while muting the audio of the media stream.

In yet another detailed aspect of an exemplary embodiment, multiple indicators can be stacked to encourage the system to target a subset of ad buckets assigned to the media stream. For example, multiple key-value pairs can be placed in the steam in stacked sequence prior to the transition, which would cause the system to make a request to an ad server to first query the highest priority ad bucket, advertiser, or ad for each key-value pair in the stack.

A system for presenting advertisements in association with a media stream is also provided that includes a metadata harvester configured to monitor a plurality of media streams for transition indicators preceding advertisement segment. The indicator can include timing information of the duration the advertisement segment. The system further includes an advertisement module for transmitting a replacement advertisement instructions to a client device accessing the media stream prior to the transition, such that the replacement advertisement is received by a client device separate and distinguishable from the media stream in manner that the client device can play the replacement advertisement unmuted while the audio-stream component of the media stream is automatically muted without need of user action.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a perspective view of a system in accordance with the invention.

FIG. 2 is a simplified view of an exemplary media stream and advertisement(s) that can be used with the system of FIG. 1 in accordance with the invention.

FIG. 3 is a simplified graphical user interface of an exemplary media player on a client device of FIG. 1, depicting the player presenting of a content segment of a media stream on the client device.

FIG. 4 is a simplified graphical user interface of the exemplary media player of FIG. 3, depicting the player presenting a replacement advertisement during an advertisement segment of the media stream.

FIG. 5 is a simplified block diagram of a method for presenting advertisements in accordance with the invention, as conducted on a client device.

FIG. 6 is a simplified block diagram of ad buckets in accordance with the invention.

### DETAILED DESCRIPTION OF THE PREFERRED EMBODIMENTS

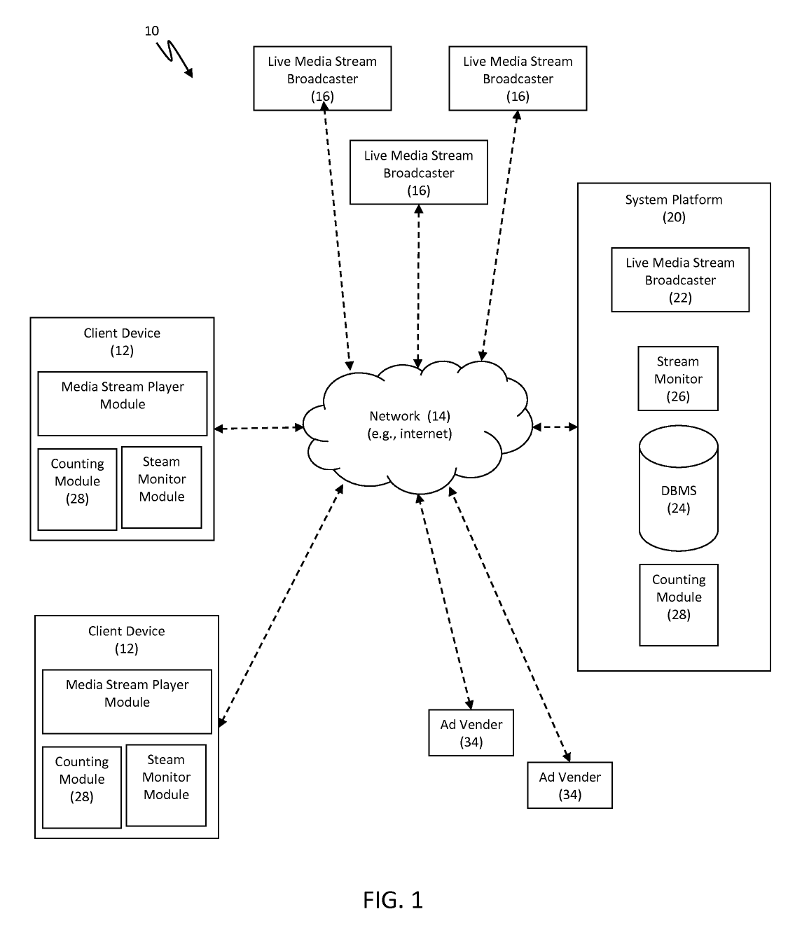

Referring now to the drawings, and particularly FIG. 1, there is shown a system 10 for presenting advertisements to users of client devices 12 accessing a media stream over the communications network 14. The advertisements are intended to be presented to the user rather than advertisements embedded in the media stream. These replacement advertisements may be sold at higher ad rates than those embedded in the media stream, resulting in higher ad revenues.

Media streams typically include content segments and advertisement segments in serial sequence. For example, the content segment of an Internet radio station could include several songs. The content segment would be followed by an advertisement segment from 15 seconds to several minutes, wherein one or more advertisements would be presented to the listener. Thereafter, the media stream would return to a subsequent content segment. The system monitors the media stream for indicators of upcoming advertisement segments. Once an advertisement segment has been identified, the system provides a replacement advertisement for presentation to the user on the client device. The playback of replacement advertisements is coordinated with the media stream for a defined duration sequenced with an advertisement component of the media stream, so that the replacement advertisement will terminate prior to initiation of a subsequent program component of the media stream. More particularly the system will mute the audio stream component of the media stream and play the replacement advertisement. The replacement ads can be selected and presented to the user in real time.

In this manner, the system provides broadcasters the ability, to control and modify advertisements presented to users without interfering with the media stream. More specifically, broadcasters can insert or update advertisements presented to end users, without interrupting the primary media stream. As a result, broadcasters can target end-users with personalized advertisements, thereby optimizing advertising revenue in a convenient manner.

With continued reference to FIG. 1, connections between components are shown using double-sided arrows, which may be physical, fiber optic, wireless, or any other type of communications link. Client devices 12 are connected to broadcasters 16 of media streams—over the network 14. The network 14 can be any of a variety of conventional network topologies and types (including optical, wired and/or wireless networks), using a variety of conventional network protocols (including public and/or proprietary protocols). The network 14 can include, for example, home networks, cellular networks, a corporate networks, Intranet(s), or the Internet, as well as possibly at least portions of one or more local area networks (LANs) and/or wide area networks (WANs) or telephone networks, among others.

Client devices 12 can receive streaming media content via the network 14 from a broadcaster 16. Broadcasters can make media streams available at different bitrates to accommodate users with differing bandwidth capacity, enabling a client device to request a media stream at an optimal bitrate for its circumstances.

The client devices 12 may be any of a variety of digital devices, including, for example, a desktop PC, a notebook or portable computer, a workstation, an Internet appliance, a gaming console, a handheld PC, a cellular telephone or other wireless communications device, a personal digital assistant (PDA), a set-top box, combinations thereof, and other devices otherwise capable of receiving a media stream.

Broadcasters 16 (FIG. 1) generally store media content and streams media content to users. The media stream is provided over the network 14, e.g., Internet. The broadcaster can provide any of a variety of data for inclusion in the media stream for streaming over the network, including content such as audio, video, text, images, animation, and the like. However, as used herein with respect to the exemplary embodiments described below, media content is intended to represent audio/video (A/V) content or just audio content. Furthermore, references made herein to “media content,” “streaming media”, or “media stream”, and any variation thereof are generally intended to include audio/video content or just audio content. The term “streaming” is used to indicate that the data representing the media content is provided over the network 14, thereby available to be accessed by the client devices 12 for playback, whether or not the stream is compressed, packetized, encrypted. Examples of streaming protocols known in the art include, e.g., to include intermingled audio/video data and metadata, multicast, MPEG-2 streams, Real-time Streaming Protocol (RTSP) or Real-time Transport Protocol (RTP), HTTP Live Streaming (HLS), Flash HTTP Streaming HDS, and ICY, among others. In the exemplary embodiment, playback of the media stream can initiate and continue, prior to the content of the media stream being delivered to the client device in its entirety. Rather, once a sufficient amount of the media stream is buffered by the client device, playback can initiate.

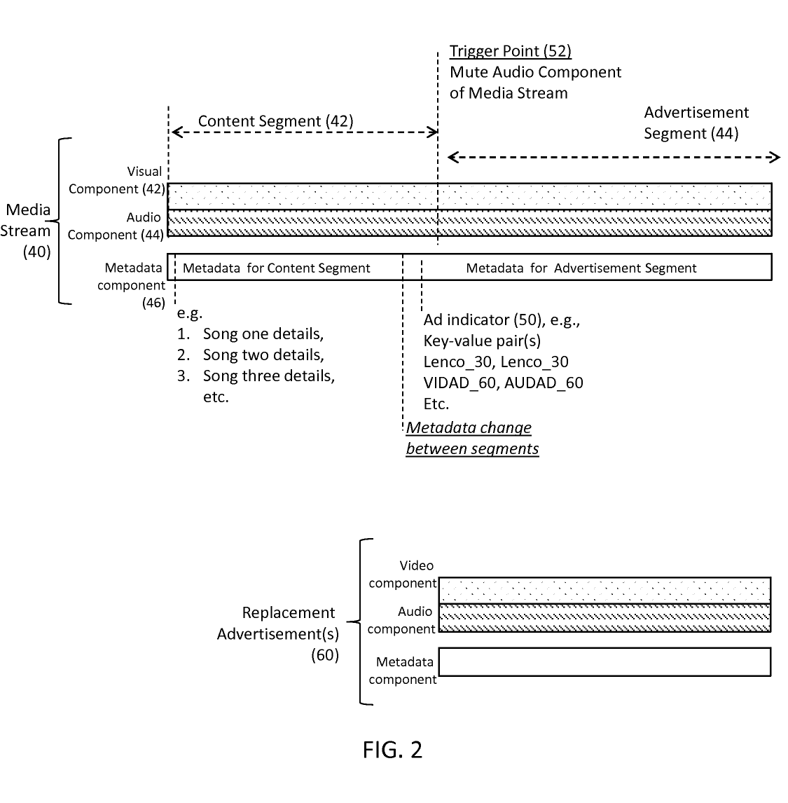

With reference now to FIG. 2, an exemplary media stream 40 is shown, which includes content segments 42 separated by advertisement segments 44, at periodic intervals. The media stream includes metadata 46 that provides, among other things, detailed information about the segments. For example, in a media stream for an Internet radio station, the metadata for the content segment could include detailed information about the songs played during a content segment, to include artist, album, title, and duration. The metadata 46 for the advertisement segment could include details about the advertiser(s) and ad duration(s) as well as segment duration. The metadata 46 changes prior to actual changes within and between segments of the media stream. For example, changes in metadata describing a song will precede a change in songs within the content segment. The change between segments will also be preceded by changes in metadata.

For convenience of illustration only, and not by way for limitation, the visual component, the audio component, and the metadata of the media stream are depicted as distinct from one another and as continuous streams. It will be appreciated by those of ordinary skill in the art to be a helpful simplification to depict broad concepts, not an exact depiction of the stream structure or format. As mentioned above, the media streams can utilize any of the various formats used in the art.

With reference again to FIG. 1, a system platform 20 is provided, which communicates with client devices 12 over the network 14. The system platform further monitors all of the media streams of the system. The system can utilize media streams of various formats and sources; e.g., (a.) media streams can be accessed over the network 14 from third-party broadcasters 16, (b.) the system platform can be configured to broadcast 22 one or more media streams, and (c.) the system platform can relay or rebroadcast media streams received from a third-party broadcaster. Other scenarios can be used for distributing and monitoring media streams to end users.

The system platform 20 includes a stream monitor 26 that monitors all of the various media streams accessed by users of the system. The stream monitor 26 is configured to identify ad indicators within the media streams. In the exemplary embodiment, the stream monitor 26 harvests the metadata from the media stream. The stream monitor 26 can be configured to handle any format of metadata, e.g., ICY, RAW/Embedded, among others. The harvested metadata is used for several purposes. For example, the system maintains a listing of all content information available on the media streams of the system. In this way, users have convenient access to a listing of content that is presently available on each of the media streams, so that the user can select the media stream of interest.

In the exemplary embodiment, the stream monitor 26 includes a meta-harvesting engine that retrieves metadata from all of the media streams under management of the system. The harvesting engine is designed to monitor the population of media streams, retrieving metadata from each of the media streams, which could include in excess of 10,000 different streams, to harvest, store, and forward content information such as album, artist, and song data, making it available to players, search, and end-user consumable content.

The system platform 20 maintains a log of all users and of all media streams of the system. In use, the system platform 20 tracks which of the plurality of media streams the client devices are accessing at any time. The system platform 20 further maintains additional information concerning the client device and user, to include listener demographics, location, language settings, and time, among other things. The system platform maintains such information within a database management system (DBMS) 24. This information can be utilized to optimize ad revenue for the replacement advertisements 60. Other targeting characteristics such as gender, location, and census based demographics as well as third party scoring services can all be employed as well.

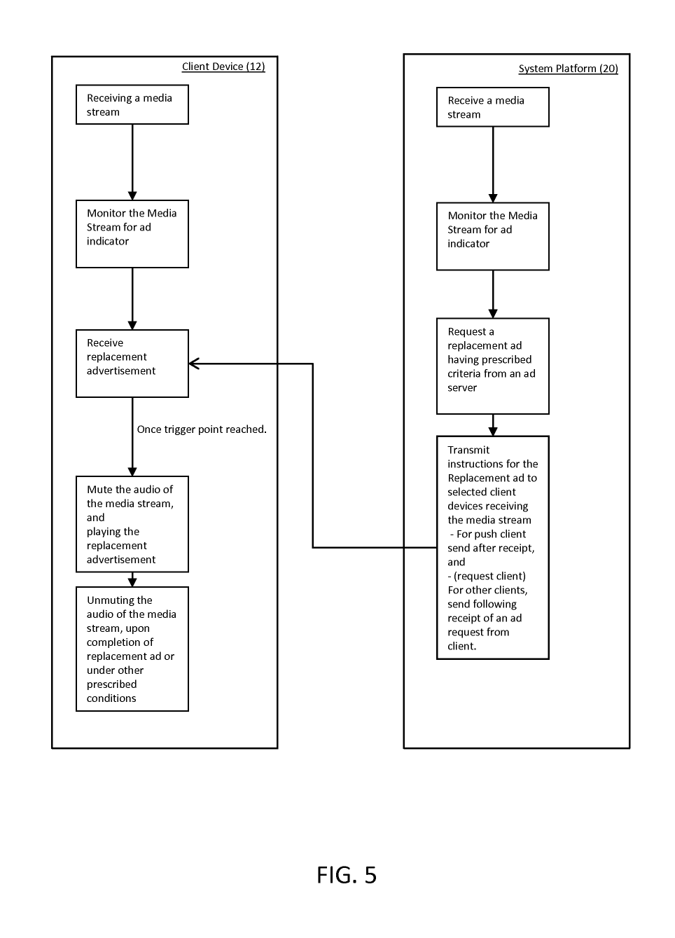

With reference to FIGS. 2 and 5, the stream monitor 26 further analyzes the media stream for ad indicators, to include indicators within the metadata. In one embodiment, indicators include key/value pairs having prescribed naming conventions. For example, a “key” can be one of a selected list of terms recognized by the system, and is followed by a “value” that indicates the duration or length of the upcoming advertisement segment. The system could be configured so different key terms are used to initiate various different types of actions. For example, key terms such as “AUDAD” would initiate a system to retrieve an audio only advertisement, whereas key term such as “VIDAD” would initiate the system to retrieve a video advertisement. In this manner, the system can be tailored to perform various actions by recognizing such indicators in the media stream. The system can further indicate the end of an advertisement segment and the beginning of a subsequent content segment to ensure that the player 70 returns to the content, even if the replacement advertisements run over the allotted time. In the exemplary embodiment, the following metadata string is recognized as an indicator for sixty second video advertisement spot, as follows:
e.g. (String_VIDAD_{—}60_String-String)

In addition or alternatively, advertising indicators can further include other variations within the media stream designed and positioned to precede an advertisement segment. Other examples of indicators could include tones embedded in the audio content of the media stream having a prescribed format. Preferably, although not necessary, tone is formatted to convey information to the system including duration of the upcoming advertisement segment, which can be achieved using a tone having varying frequency such as sine based tones. Such tones can be used that are inaudible to the human ear. Silence having a prescribed format can also be used as an indicator within the media stream. Once an identifier is detected in the stream, it can initiate a byte counter and/or the trigger, as discussed in further detail herein. Other configurations of indicators can be used without departing from the invention.

With continued reference to FIG. 5, the client device 12 and the system platform 20 retrieve a media stream and monitor for ad indicators. When an ad indicator 50 is recognized, the system platform 20 communicates with one or more ad providers to request a replacement advertisement having prescribed criteria, as shown in step three for the system platform 20. The request to the third-party ad vendors 34 can include sufficient information insured targeted advertisements are provided to optimize ad revenue. Such information can include listener criteria (such as, user demographics, location, language, among others) and media stream criteria (such as, content details, genre, listener demographics, among others) indicators. Other criteria such as device type, operating system, display characteristics, behavioral information are all leveraged, Additional criteria could include IP address, browser type, operating system, stored cookie information, and frequency caps (i.e., amount of times a user has seen the same ad or an ad from the same ad provider).

Advertisers commonly pay higher rates for ad placements that are precisely targeted to particular classifications of user, whether demographic, location, or other factors. In this manner, ad revenue can be optimized. In an exemplary embodiment, listener location and station details are used to select the highest value advertisements. The station configuration includes but is not limited to target demographics, language, genre, and keywords/tags.

In the exemplary embodiment, various third party ad servers/platforms/vendors for advertisement fulfillment can be used, such as, e.g., LiveRail® available from LiveRail Inc., ad-serving tools from Google, Inc., YuMe, Inc., Tremor Video, Inc., and Adap.tv, Inc., among others. Ad requests and fulfillment can take advantage of real-time bidding for ad vendors 34, which can further optimize revenue. In addition, or alternatively, the system platform can maintain the queue of advertisements that can be used for ad fulfillment. Thus, the originator can delegate ad placement responsibilities and/or ad revenue optimization with contracted third parties. If the request returns advertisement(s) that satisfy the request, the system platform will transmit instructions to the client device so that it can retrieve the replacement ad, as shown in step 4 for the system platform 20. In the exemplary embodiment, the system will push the ad instructions to client devices that are configured to receive push instruction. For request clients, the system platform will send instructions for retrieving the replacement ad upon receipt of a request from the client device.

The client device 12 will play the replacement ads as appointed, once the trigger point is reached, as shown in FIG. 5. Otherwise, the client device makes new request(s) or additional attempts at filling the ad slot/opportunity. It does this by targeting alternative Ad Buckets received as part of the ad strategy; in this manner, the ad strategies minimize the risk of lost opportunity. Replacement advertisements are sold at higher ad rates than those embedded in the media stream. Replacement advertisements may be selected on other criteria. For example, a lower paying ad might be selected with higher volume allocation, or to establish the advertiser relationships. The client device place the replacement advertisements 60 in an ad queue 30, waiting to play the ad(s) once a trigger point 52 is reached.

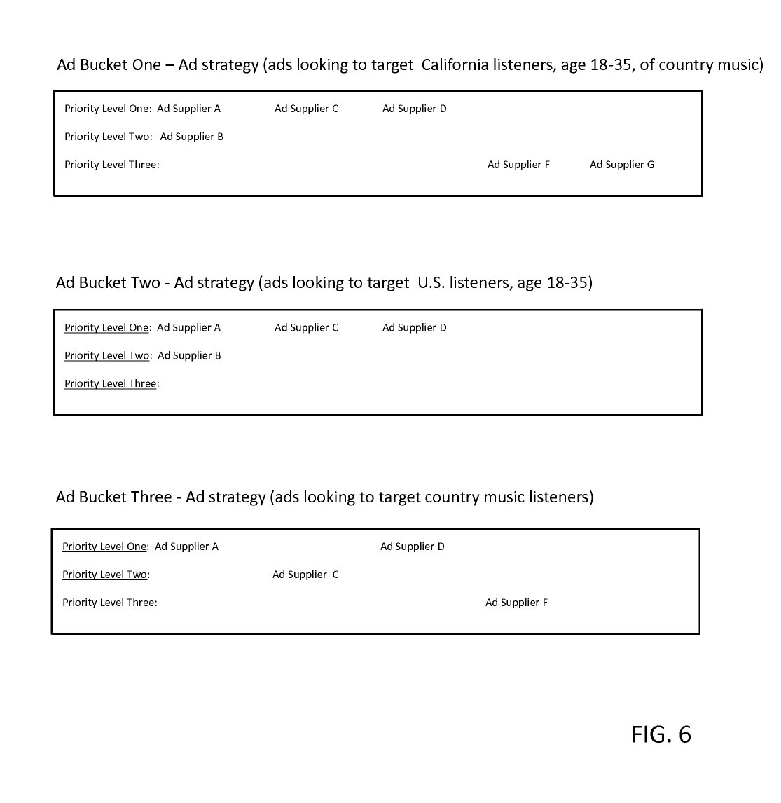

With reference to FIG. 6, the system 10 can further utilize multiple ad queues (a.k.a., ad buckets). In the exemplary embodiment, each ad bucket is assigned a particular advertisement strategy. For example, an ad bucket can have a strategy to target listeners by geographic region, demographic, media format (e.g., talk radio, news, country music, etc.) A single media stream can have several ad buckets assigned to it. In such a scenario, when an ad trigger is identified, the system will cycle sequentially through each ad bucket (e.g., ad bucket 1, ad bucket 2, etc.) to fulfill the time slot for the ad segment, if possible. The system rotates through these items as and when they are played. Once all ad buckets have been played the player returns to the first bucket.

As mentioned above, the key component of the key-value pair can be used by the system to elect a particular subset of ad buckets for use. In such scenarios, the system would focus on the buckets associated with the key-value pair identified in the media stream.

Within each ad bucket, the system can prioritize ad suppliers with priority levels. For example in Ad Bucket One, the system will first send ad requests to the ad suppliers of Priority Level One (Ad Suppliers A, C, and D). The ad supplier that returns with the highest paying ad spot will get the ad placement. If Priority Level One does not return an ad, then the request will be sent the ad supplier(s) of Priority Level Two. If the ad request is satisfied, then it will receive the ad placement. If not, then the ad request will be sent to ad supplier(s) of Priority Level Three, and so one. An Ad Bucket can have one or more priority levels. If none of the ad suppliers of Bucket One fulfills the ad request, the system will proceed to the next Ad Bucket in the sequence.

With reference again to FIGS. 1 and 2, a counting module 28 is utilized to determine the trigger point 52 for sequencing the start time of the replacement advertisement with the transition between the content segment 42 and the advertisement segment 44 of the media stream 40. The counting module 28 utilizes the bitrate and the buffer time of the stream to calculate a target count that indicates how many bytes the metadata is ahead of the actual transition between the segments.

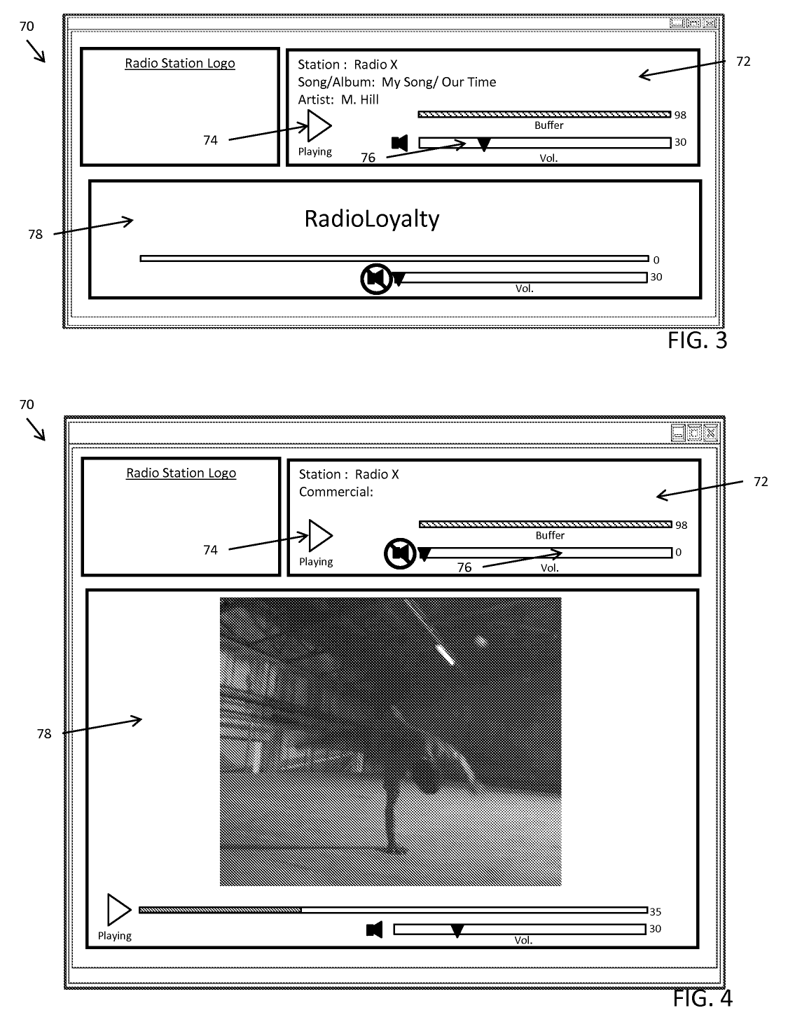

The counting module 28 maintains a record of the number of bytes in the stream buffer (FIGS. 3 and 4). By way of example, where a buffer (FIGS. 3 and 4) maintains approximately 100,000 bytes of the media stream, for a stream having bitrate of 128 k bit/sec. would roughly correlate to about twenty seconds of content playtime housed in the buffer. This means that the buffer is housing twenty seconds of media stream playtime, not that there is a twenty-second lag in terms as related to the system clock for the client device. Various system delays, communications interruptions, of other factors may cause a variation in stream playtime and the system clock. In this manner, the byte counter aids in accounting for these variations thereby synchronize the replacement advertisement with the media stream.

The counting module 28 tracks the interval between receipt of an ad indicator and the transition between segments. More particularly, once the ad indicator 50 is recognized, the counting module 28 start counting the bytes received by the media stream to determine the trigger point. This count is referenced as the “current byte count.” In the exemplary embodiment, the trigger point identified as when “Current Byte Count” meets or exceeds the “Initiator Lead Count” (determined as the “stream bitrate” times (Buffer Size—Interval), in which the “Interval” is the ratio of metadata interval to bitrate. At the trigger point, system initiates replacement ad and mutes media stream.

When an ad indicator 50 is identified, the player starts the triggering calculation. As the player gets closer to the trigger, the player can fade out the sound of the media stream. The sound fade out is conducted over a short duration (e.g., 1-3 sec.). The fade out of the audio aides in addressing any minor discrepancies in the trigger time calculation, providing the listener with a smooth transition between the content sound and the replacement advertisement sound.

With reference again to FIG. 2, multiple ad indicators 50 (e.g., key-value pairs such as VIDAD_{—}60, VIDAD_{—}60) can be stacked immediately adjacent to one another in the stream metadata, resulting in multiple replacement advertisement being played in sequence. In this example, the “60” value represents a sixty-second ad spot. With two pairs stacked in the metadata, the system would have 120 seconds for replacement advertisements it could provide. Optionally, the system could queue four thirty-second ads or two sixty-second ads. Stacking the ads ensure that the system will seek at least two ads, rather than providing a single 120 second ad.

Moreover, the ad indicators can be stacked adjacent to one another so that a subset of one or more ad buckets for the media stream as targeted for play. For example, multiple key-value pairs can be placed in the steam in stacked sequence prior to the transition, which would cause the system to first query the highest priority ad bucket for each key-value pair in the stack.

With reference now to FIGS. 3 and 4, a graphical user interface (GUI) for a media player 70 is shown. The player includes a panel 72 for controlling playback of the media stream. The stream panel 72 includes play/pause button 74, volume control 76, and a buffer indicator 76. In the exemplary embodiment, the buffer indicator has a scale to from zero to 100, showing the percentage capacity of the buffer. The player further includes a replacement advertisement panel 78, apart from the stream panel 72. As best seen in FIG. 4, when triggered, the replacement advertisement plays in the ad panel 78, and the volume for the media stream is muted, as shown indicated by the volume control 76. The player 70 can further include fail-safe features to address issues such as a hard stop where the replacement advertisement does not play at all or does not does not start or does not play to completion, after which the player would unmute the media stream.

Any of the methods described herein can be performed (at least in part) using software comprising computer-executable instructions stored on one or more computer-readable media. Furthermore, any intermediate or final results of the disclosed methods can be stored on one or more computer-readable media. It should be understood that the disclosed technology is not limited to any specific computer language, program, or computer. For instance, a wide variety of commercially available computer languages, programs, and computers can be used.

It should be appreciated from the foregoing that the present invention provides a computerized system and method for presenting advertisements in association with a media stream in a network environment, without interruption to the media stream. The advertisements are provided in a real-time and targeted manner to maximize advertisement revenue. The advertisements replace advertisements otherwise provided within the media stream.

Although the invention has been disclosed in detail with reference only to the exemplary embodiments, those skilled in the art will appreciate that various other embodiments can be provided without departing from the scope of the invention. Accordingly, the invention is defined only by the claims set forth below.

What is claimed is:

1. A computerized method for presenting advertisements in association with a media stream, comprising:
playing a media stream on a client device received from a stream server over a network, the media stream including an audio component, the media stream including a content segment and an advertisement segment in serial sequence separated by a transition;
monitoring the media stream for an indicator for the advertisement segment, the indicator including timing information of the duration of the scheduled advertisement segment;
receiving a replacement advertisement having an audio component over the network, prior to the transition;
identifying a trigger point indicating the transition from the content segment to the advertisement segment
muting the audio-stream component of the media stream, upon initiation of the advertising segment of the media stream; and
playing the replacement advertisement on the client device with the replacement advertisement unmuted, the playing step sequenced by the trigger point such that the replacement advertisement is initiated to play unmuted while the audio component of the media stream is played muted, without need of user action.

2. The method as defined in claim 1, wherein the replacement advertisement has a duration less than or equal to the duration of the advertisement segment of the media stream, as identified by the indicator.

3. The method as defined in claim 1, wherein:
the receiving step includes receiving a plurality of replacement advertisements prior to the transition, the plurality of replacement advertisement having a cumulative duration less than or equal to the duration of the advertisement segment; and
the playing step includes playing the plurality of replacement advertisements during the advertisement segment in sequence.

4. The method as defined in claim 1, wherein the replacement advertisement further includes a video component.

5. The method as defined in claim 1, wherein the identifying step includes a byte counter configured to measure the bitrate and buffer time of the media stream.

6. The method as defined in claim 1, wherein the indicator includes a key-value pair provided in metadata of the media stream, in which the value is indicates the duration of the advertisement segment.

7. The method as defined in claim 6, wherein multiple key-value pairs are placed in the steam in stacked sequence prior to the transition.

8. A computerized method for presenting advertisements in association with a media stream, comprising:
monitoring a media stream including an audio component, the media stream having a content segment and an advertisement segment in serial sequence separated by a transition for at least one indicator of the advertisement segment, the indicator including timing information of the duration the advertisement segment, the monitoring step includes monitoring for the indicator; and
transmitting instructions to a client device that is accessing the media stream prior to the transition that facilitate the client device to receive the replacement advertisement as separate and distinguishable from the media stream so that the client device can play the replacement advertisement unmuted while the audio component of the media stream is automatically muted without need of user action.

9. The method as defined in claim 9, further comprising: maintaining a real-time listing of system users accessing the media stream.

10. The method as defined in claim 9, wherein the at least one indicator includes a key-value pair provided in metadata of the media stream, in which the value is indicates the duration of the advertisement segment.

11. The method as defined in claim 9, further comprising:
transmitting a request to a real-time bidding platform, following identification of the at least one indicator and prior to the transition; and
receiving information from the ad-bidding platform sufficient to access the replacement advertisement, for use in the transmission step.

12. The method as defined in claim 12, wherein the request includes information related to a system user receiving the media stream, the information from a group consisting of location, demographics, and language.

13. A system for presenting advertisements in association with a media stream, comprising:
a metadata harvester configured to monitor a plurality of media streams, each media stream having a content segment and an advertisement segment in serial sequence separated by a transition for at least one indicator of the advertisement segment, the indicator including timing information of the duration the advertisement segment, the monitoring step includes monitoring for the indicator; and
an advertisement module for transmitting instructions to a client device that is accessing the media stream prior to the transition that facilitate the client device to receive the replacement advertisement as separate and distinguishable from the media stream so that the client device can play the replacement advertisement unmuted while the audio component of the media stream is automatically muted without need of user action.

14. The system as defined in claim 14, further comprising: a database management system (DBMS) that maintains a real-time listing of system users accessing the media stream.

15. The system as defined in claim 14, wherein the at least one indicator includes a key-value pair provided in metadata of the media stream, in which the value is indicates the duration of the advertisement segment.

16. The system as defined in claim 14, wherein the advertisement module is configured to transmit a request to an ad-bidding platform, following identification of the at least one indicator and prior to the transition; and to receive the replacement advertisement from the ad-bidding platform, for use in the transmission step.

17. The system as defined in claim 14, wherein the request includes information related to a system user receiving the media stream, the information from a group consisting of location, demographics, and language.
